(19) United States
(12) Patent Application Publication
(10) Pub. No.: US 2026/0149207 A1
(43) Pub. Date: May 28, 2026

(54) Electrical Connector Contact and Connection Element with Electrical Connector Contact

(71) Applicant: TE Connectivity Solutions GmbH, Schaffhausen (CH)

(72) Inventors: Roland MOEDINGER, Schaffhausen (CH); Holger FRÖHLICH, Schaffhausen (CH); Gerhard LUCK, Schaffhausen (CH)

(73) Assignee: TE Connectivity Solutions GmbH, Schaffhausen (CH)

(21) Appl. No.: 19/358,476

(22) Filed: Oct. 15, 2025

(30) Foreign Application Priority Data
Oct. 18, 2024 (DE) 102024130366.2

(51) Int. Cl. H01R 13/03; H01R 13/04; H01R 13/52

(52) U.S. Cl. CPC H01R 13/03; H01R 13/04; H01R 13/521

(57) ABSTRACT

An electrical plug connector contact and a terminal element. The electrical plug connector contact has a terminal section for contacting with a complementary further electrical plug connector contact. A first galvanic nickel layer is positioned atop the terminal section. A second galvanic nickel layer is positioned atop the first galvanic nickel layer. The terminal element has a housing, a printed circuit board positioned on the housing and at least one electrical plug connector contact positioned within the housing and connected to the printed circuit board. The terminal element is provided for connection to a complementary further terminal element having at least one further plug connector contact complementary to the electrical plug connector contact.

### CROSS-REFERENCE TO RELATED APPLICATION

This application claims the benefit of German Patent Application No. 102024130366.2 filed on Oct. 18, 2024 in the German Patent Office, which is hereby incorporated by reference in its entirety.

### BACKGROUND OF THE INVENTION

The present invention relates to an electrical plug connector contact and to a terminal element with an electrical plug connector contact.

The prior art discloses electrical plug connector contacts.

### SUMMARY OF THE INVENTION

It is an object of the present invention to provide an improved electrical plug connector contact and a terminal element with an electrical plug connector contact. This object is achieved by an electrical plug connector contact and a terminal element having the features of the independent claims. Advantageous developments are specified in dependent claims.

An electrical plug connector contact has a terminal section for contacting with a complementary further electrical plug connector contact. A first galvanic nickel layer is positioned atop the terminal section. A second galvanic nickel layer is positioned atop the first galvanic nickel layer.

In one embodiment, the electrical plug connector contact has a solder section fixedly bonded to the terminal section. The terminal section and the solder section are arranged opposite one another in relation to an assembly direction of the electrical plug connector contact. A solder bond can be positioned atop the solder section. The first galvanic nickel layer is positioned atop the terminal section and atop the solder section. The second galvanic nickel layer is positioned solely in the region of the terminal section atop the first galvanic nickel layer. The second galvanic nickel layer is positioned solely in the region of the terminal section. The solder section, by contrast, remains clear and uncovered by a second galvanic nickel layer. The second nickel layer, in terms of tribology for optimized layer hardness, has been electrolyzed solely in the region of the terminal section.

The electrical plug connector contact may take the form of a male or female connector. The electrical plug connector contact may be intended for installation in a panel plug or socket, or to be part of a panel plug or socket. The electrical plug connector contact may, for example, be part of or be provided for what is called a backplane bus. This means that the electrical plug connector contact may be used, for example, in control cabinets.

The terminal section is designed to connect the electrical plug connector contact to a complementary further electrical plug connector contact. In the terminal section, an electrical contact is thus made with the further electrical plug connector.

The solder section is designed to connect the electrical plug connector contact to a printed circuit board (PCB). The solder section has a solder region opposite the terminal section in relation to assembly direction. The solder section can also be referred to as a solder leg. The solder section is thus provided in the solder region facing away from the terminal section for connection of the electrical plug connector contact to a printed circuit board. The solder bond between the solder section and the printed circuit board can be made, for example, by means of a surface mount technology (SMT) or, for example, by means of what is called through-hole reflow technology (THR). The printed circuit board can also be referred to as a plug-assembled printed circuit board.

The electrical plug connector contact comprises a base material, for example a copper alloy. However, the base material may alternatively comprise a zinc, tin, silicon, nickel, iron and/or steel alloy. The first galvanic nickel layer is positioned atop the base material. The first galvanic nickel layer preferably fully covers the terminal section. The second galvanic nickel layer is positioned atop the first galvanic nickel layer and preferably fully covers the first galvanic nickel layer, meaning, for example, that the second galvanic nickel layer fully covers the first galvanic nickel layer in the terminal section including its galvanic layer outlets.

In one embodiment, a third galvanic nickel layer is positioned atop the second galvanic nickel layer. The third galvanic nickel layer takes the form of an adhesion promoter layer. In one embodiment, the third galvanic nickel layer is disposed atop the first galvanic nickel layer in the region of the solder section.

The third galvanic nickel layer may be called a galvanic nickel strike layer. The third galvanic nickel layer is designed to remove oxidized nickel species in the region of the solder section in the first galvanic nickel layer and in the region of the terminal section in the second galvanic nickel layer. Thus, the third nickel layer advantageously enables a further layer structure with improved adhesion.

In one embodiment, a fourth galvanic nickel layer is positioned above the second galvanic nickel layer. The fourth galvanic nickel layer includes phosphorus. In one embodiment, the fourth galvanic nickel layer has a phosphorus content of 11-16%-wt. If the third galvanic nickel layer is provided, the fourth galvanic nickel layer is positioned atop the third galvanic nickel layer. If the third galvanic nickel layer is not provided, the fourth galvanic nickel layer is positioned atop the second galvanic nickel layer.

In one embodiment, the first galvanic nickel layer takes the form of a matt nickel layer. The second galvanic nickel layer takes the form of a moderately shiny or highly shiny nickel layer.

In one embodiment, the second galvanic nickel layer includes a fine-grain additive. The first galvanic nickel layer does not include a fine-grain additive in one embodiment. The fine-grain additive in one embodiment includes, for example, an ionic and/or an anionic and/or a nonionic surfactant and/or a derivative of the ionic and/or anionic and/or nonionic surfactant and/or a mixture of said surfactants. A surfactant can also be referred to as a wetting agent component. The surfactants may be in cationic or anionic form. Nonionic surfactants are electrically uncharged. In one embodiment, the first galvanic nickel layer does not include any fine-grain additive.

The galvanic nickel layers are also referred to hereinafter as nickel layers for the sake of simplicity. The nickel layers may be galvanically deposited on the electrical plug connector contact. The nickel layers may be deposited by chemical reduction at the electrical plug connector contact either electrolytically or without external current. For example, the nickel layers may be galvanically deposited using a nickel sulfamate bath. A nickel layer produced in this way is highly pure (at at least 99%-wt, for example), has high hardness and offers corrosion protection for the electrical plug connector contact. The galvanic nickel layers, each in the form of matt nickel, moderately shiny or highly shiny nickel layers, can each be deposited using a nickel sulfamate bath. Nickel sulfamate can also be referred to as nickel(II) amidosulfate. Alternatively, instead of a nickel sulfamate bath type, it is also possible to use a galvanic Watts nickel bath or a galvanic nickel strike bath for the galvanization of the respective nickel layers. However, the nickel layers may alternatively also be galvanically deposited with addition of a fine-grain additive.

These nickel layers each have the function of a barrier layer to the base material, and also a levelling and layer stress-dissipating functionality. On the base material of the electrical plug connector contact, the first galvanic nickel layer is preferably galvanized as a matt nickel layer that is free of fine-grain additive and hence ductile. The second galvanic nickel layer preferably includes the fine-grain additive and thus takes the form of a moderately shiny to shiny nickel layer and is electrolytically deposited onto the first matt nickel layer.

The third galvanic nickel layer is the nickel strike layer for promotion of adhesion, which is preferably fully galvanized over the terminal region and over the solder bond region. The subsequent fourth galvanic nickel layer is the nickel-phosphorus layer, which is likewise preferably fully metallized over the terminal region and solder bond region.

In this embodiment, the first nickel layer takes the form of a matt nickel layer, while the second nickel layer takes the form of a moderately shiny or highly shiny nickel layer. However, it may also be that the first nickel layer takes the form of a moderately shiny or highly shiny nickel layer and the second nickel layer takes the form of a matt nickel layer. The first and second nickel layers may also both take the form of a matt nickel layer or both of a moderately shiny nickel layer or of a highly shiny nickel layer. If a nickel layer takes the form of a moderately shiny or highly shiny nickel layer, it may include a fine-grain additive. Also, the third and fourth nickel layers may each include a fine-grain additive or be deposited using a fine-grain additive, although this is not required.

The first and second nickel layers may be deposited, for example, on blank punched strips or blank punched strip sections or singularized bulk material punched contacts. Subsequently, these galvanic contacts or galvanic contact strips are assembled to electrical plug connectors. Substrates employed for electroplating include, for example, blank punched strips, blank punched strip sections or singularized bulk material punched contacts. The galvanic contacts or galvanic contact strips galvanized in this way are assembled to electrical plug connectors in a subsequent manufacturing step.

The first and second nickel layers are polycrystalline and have crystallites or grains separated by grain boundaries. The first and second nickel layers have different microstructures in the embodiment, since the second nickel layer in this case includes the fine-grain additive. Compared to the first nickel layer which has a coarse-grain structure, the second nickel layer has a fine-grain structure. It is thus important merely that the second nickel layer has a fine-grain structure in relation to the first nickel layer, or that the first nickel layer has a coarse-grain structure in relation to the second nickel layer. Absolute grain sizes, for example, are insignificant and are not considered explicitly.

In one embodiment, a grain size of crystallites of the second galvanic nickel layer is smaller than a grain size of crystallites of the first galvanic nickel layer. The fact that the grain size of the crystallites of the second galvanic nickel layer is smaller than the crystallites of the first galvanic nickel layer means that at least some of the crystallites of the second galvanic nickel layer have smaller grain sizes on average at least in one direction of extension than the crystallites of the first galvanic nickel layer. It may be that the grain sizes of the first and second nickel layers are similar or identical. The grain sizes of the first and second nickel layers can be determined, for example, according to standards ASTM E112 and DIN EN ISO 643.

In addition to grain sizes, grain boundary densities of the nickel layers can also be considered in order to distinguish the microstructures from one another. In one embodiment, a density of grain boundaries of the second nickel layer is greater than a density of grain boundaries of the first nickel layer. The first nickel layer shows isotropic layer growth with few grain boundaries compared to the second nickel layer. The second nickel layer has a higher number of grain boundaries and a more fine-grain microstructure.

The second nickel layer is less ductile compared to the first nickel layer, but has a higher hardness or layer hardness/hardness properties. The higher hardness of the second nickel layer compared to the first nickel layer may be caused, for example, by a higher grain boundary density since cracks typically spread along grain boundaries and a higher density of grain boundaries reduces the probability of spread.

The fine-grain additive acts as an inhibitor for anisotropic layer growth and is incorporated into the microstructure in the course of galvanic metallization, hence influencing the growth and growth rate along specific crystallographic orientations of the crystallites and grain boundaries. Fine-grain additives can reduce the crystallite size and/or cause formation of rounded crystallites. Galvanic nickel layers containing fine-grain additive are, according to the voltage series, baser and moderately shiny to highly shiny, compared to more noble matt nickel layers that are galvanically free of fine-grain additive.

The first nickel layer is visually characterized in that it has a matt appearance in the uncovered state in terms of its surface appearance compared to the second nickel layer. As a result of this described galvanic multilayer nickel structure, galvanic contacts or electrical plug connector contacts assembled to plug connectors show optimized friction and wear characteristics and an optimized lifetime for the plug product. It is thus possible to use the electrical plug connector contact, owing to the optimized nickel layer hardness of the second nickel layer, in applications in which the electrical plug connector contact in the terminal region is subject to relatively high mechanical stresses, for example vibrations. Advantageously, the fourth nickel layer, in particular by virtue of the high phosphorus concentration of 11-16%-wt, additionally improves the wear properties in the terminal section, since the fourth nickel layer has particularly high hardness.

The fact that the second nickel layer includes a fine-grain additive means that the deposited second nickel layer includes components of the fine-grain additive that are incorporated into the second nickel layer in the course of galvanic deposition and hence influence the growth of the crystallites and grain boundaries.

The fine-grain additive, in one embodiment, includes primary and/or secondary shine formers and/or derivatives of the primary and/or secondary shine formers, which also achieve a levelling effect for the galvanic nickel metallization for a subsequent galvanically anisotropic and homogeneous layer structure.

The shine former includes a shine carrier and/or at least one shine additive. Shine carriers are also referred to as primary shine agents and cause distinct reduction in the size of the deposited crystallites. Shine additives are also referred to as secondary shine agents and on their own cause layers that already have high shine but are usually brittle. In combination with shine carriers, it is possible to bring about fixed high shine.

In one embodiment, the shine former comprises one of the following materials: a sulfoximide, a sulfonamide, a benzenesulfonic acid, a naphthalenesulfonic acid, an alkanesulfonic acid, a sulfinic acid and an arylsulfonate and/or an aldehyde, a thiocyanate, thiourea, acylthiourea, a sulfanylalkylsulfonic acid, a disulfide, a thiocarboxamide, a thiocarbamate, a thiosemicarbazone and/or thiohydantoins.

By additional heat treatment of the fourth nickel layer in a temperature range of, for example, T=300° C. to max. T=400° C., the fourth nickel layer can undergo a crystallite microstructure transformation. This heat treatment can convert the microstructure to a crystalline, semicrystalline and/or nanocrystalline structure. This causes layer hardening by precipitation of nickel phosphide, for instance trinickel phosphide (Ni3P). It is thus possible to achieve a maximum micro hardness in the region of 1500HV for the fourth nickel layer.

The fourth nickel layer can also be produced in such a way that a layer hardness-forming dispersion additive is added to the galvanic nickel-phosphorus bath in the course of galvanic deposition. For example, silicon carbides, silicon oxides, boron nitrides and/or aluminum ceramics may be used as a dispersion additive.

Thus, the fourth nickel layer includes the dispersion additive, which is incorporated into the fourth nickel layer in the course of deposition. A fourth nickel layer produced in this way has higher micro hardness and improved friction and wear characteristics compared to a purely galvanic nickel(-phosphorus) coating free of dispersion additives.

In one embodiment, as an alternative to the fourth galvanic nickel layer, a fourth galvanic layer is positioned above the second galvanic nickel layer. The fourth galvanic layer includes a palladium-nickel alloy, in particular a palladium-nickel alloy with 80%-wt palladium and 20%-wt nickel. The fourth galvanic layer can thus be used in the layer structure as an alternative to the fourth galvanic nickel layer. If the third galvanic nickel layer is provided, the fourth galvanic layer is positioned atop the third galvanic nickel layer. If the third galvanic nickel layer is not provided, the fourth galvanic layer is positioned atop the second galvanic nickel layer.

In one embodiment, the fourth galvanic nickel layer or the fourth galvanic layer is positioned in the region of the terminal section atop the third galvanic nickel layer or atop the second galvanic nickel layer. In one embodiment, the fourth galvanic nickel layer or the fourth galvanic layer is positioned in the region of the solder section atop the third galvanic nickel layer or atop the first galvanic nickel layer.

The second galvanic nickel layer is not positioned in the region of the solder section, since this can cause delamination of the fourth galvanic nickel layer. In order to prevent this, the fourth galvanic nickel layer is positioned in the solder section above the first galvanic nickel layer, with improved adhesion by comparison with the arrangement above the second galvanic nickel layer. This can advantageously prevent delamination of the fourth galvanic nickel layer in the solder section. Advantageously, the fourth galvanic layer may have improved adhesion to the first, second or third nickel layer compared to the fourth galvanic nickel layer.

In one embodiment, the first galvanic nickel layer fully covers the terminal section and the solder section, and the second galvanic nickel layer fully covers the first galvanic nickel layer in the region of the terminal section, and/or the third galvanic nickel layer fully covers the first galvanic nickel layer in the region of the solder section and the second galvanic nickel layer in the region of the terminal section and/or the fourth galvanic nickel layer fully covers the third galvanic nickel layer in the terminal section and in the solder section. Alternatively, selective or partly selective covering of the layers mentioned is possible in each case.

In one embodiment, the first galvanic nickel layer has a layer thickness of 0.5 μm to 3 μm and/or the second galvanic nickel layer has a layer thickness of 0.5 μm to 3 μm and/or the third galvanic nickel layer has a layer thickness of 100 nm to 1000 nm and/or the fourth galvanic nickel layer or the fourth galvanic layer has a layer thickness of 0.2 μm to 2 μm. For example, the fourth galvanic nickel layer may have a nominal layer thickness of 1 μm. The respective ranges of values of the layer thicknesses of the first, second third and fourth galvanic nickel layers or the fourth galvanic layer are merely illustrative and should be considered to be nonlimiting. Instead, it is also possible to vary from the specific values without altering the concept underlying the electrical plug connector contact.

In one embodiment, a gold layer is positioned atop the fourth galvanic nickel layer or atop the fourth galvanic layer. Advantageously, the fourth galvanic nickel layer or the fourth galvanic layer is positioned between more noble layers, since the first galvanic nickel layer, the second galvanic nickel layer and the gold layer are each more noble than the third nickel layer. For example, the gold layer may be galvanically deposited. The gold layer may also be referred to as a gold flash.

The gold layer may fully cover the fourth galvanic nickel layer in the terminal section, although this is not absolutely necessary. For example, the gold layer may have a thickness of 0.05 μm to 0.1 μm, but not limited to the specified range of values. Since the fourth galvanic nickel layer or the fourth galvanic layer and the third galvanic nickel layer are merely optional, the gold layer may alternatively also be positioned atop the second galvanic nickel layer and cover it fully, for example.

In one embodiment, the terminal section of the electrical plug connector contact takes the form of a plug and the gold layer is positioned completely in the region of the second galvanic nickel layer. In one embodiment, the terminal section of the electrical plug connector contact takes the form of a plug-type coupling and the gold layer is positioned completely in the region of the second galvanic nickel layer. However, it is not absolutely necessary for the gold layer to be positioned completely in the region of the second nickel layer, i.e. completely in the region of the terminal section. For example, the terminal section of the electrical plug connector contact may take the form of a spring coupling and the gold layer may be positioned solely in the region of a tulip of the spring coupling.

Advantageously, the electrical plug connector contact is particularly corrosion-resistant. The first and second galvanic nickel layers may each be more noble than the base material of the electrical plug connector contact from which the terminal section and the solder section are formed or shaped. Even this can protect the base material against corrosion. In addition, the first galvanic nickel layer is protected by the second galvanic nickel layer.

The second galvanic nickel layer in the embodiment takes the form of a moderately shiny or highly shiny nickel layer, and hence is less noble than the first galvanic nickel layer that takes the form of a matt nickel layer. However, the second galvanic nickel layer is more noble than the fourth galvanic nickel layer or the fourth galvanic layer, which is advantageous for the corrosion resistance of the first and second galvanic nickel layer, especially when the fourth galvanic nickel layer or the fourth galvanic layer is positioned in the terminal section between the second galvanic nickel layer and the gold layer and in the solder section between the first galvanic nickel layer and the gold layer, which is the most noble of all the above layers. The third galvanic nickel layer (nickel strike layer) is provided merely as an adhesion promoter layer for the fourth galvanic nickel layer or the fourth layer. The third galvanic nickel layer and the fourth galvanic nickel layer or the fourth galvanic layer are merely optional and can even be omitted.

The second galvanic nickel layer causes cathodic corrosion protection in the layer microstructure of the embodiment. If the second galvanic nickel layer were not to be provided in the electrical plug connector contact, the first galvanic nickel layer would function as a sacrificial anode, especially in the presence of the fourth galvanic nickel layer or the fourth galvanic layer and the gold layer. Corrosion of the first galvanic nickel layer can occur, for example, especially when the fourth galvanic nickel layer or the fourth galvanic layer has cracks and fractures. Overall, there would be an increased likelihood of corrosion of the first galvanic nickel layer, which may therefore become detached from the electrical plug connector contact.

However, the presence of the second galvanic nickel layer, which, in the embodiment, is less noble than the first galvanic nickel layer, and the fourth galvanic nickel layer or the fourth galvanic layer, which is less noble than the first and the second galvanic nickel layer, protects the first galvanic nickel layer. Even when the fourth galvanic nickel layer or the fourth galvanic layer is cracked, the first galvanic nickel layer is protected against corrosion in the presence of the second nickel layer.

In one embodiment, a sealing layer is positioned atop the gold layer. The sealing layer includes an inorganic material or an organic material. For example, the sealing layer may include a thiol. The sealing layer is intended to fill cracks in the gold coating and additionally protects the electrical plug connector contact advantageously in the terminal section. The sealing layer preferably fully covers the gold layer.

In one embodiment, a tin layer is positioned atop the fourth galvanic nickel layer in a region opposite the terminal section based on assembly direction. The tin layer is thus not positioned completely in the region of the solder section, but solely in a region which is opposite the terminal section. The tin layer defines the solder region of the solder section for connection to a printed circuit board. The fourth galvanic nickel layer or the fourth galvanic layer advantageously forms a diffusion barrier to the tin layer. For example, the tin layer may have a thickness of 2 μm to 6 μm, but it is not limited to the range of values specified. The tin layer may also be referred to as a solder metal.

In one embodiment, a lubricant layer is positioned atop the gold layer or atop the sealing layer. The lubricant layer preferably fully covers the gold layer or the sealing layer. The lubricant layer includes perfluoropolyether (PFPE), for example. However, the lubricant layer may also include a different material. The lubricant layer may also be referred to as galvanic contact greasing. The lubricant layer can be applied particularly homogeneously to the gold layer or the sealing layer. Advantageously, the lubricant layer additionally reduces the wear of the electrical plug connector contact on connection of the electrical plug connector contact to the complementary further electrical plug connector contact. If no gold layer is provided, the lubricant layer is positioned atop the fourth galvanic nickel layer or the fourth galvanic layer and preferably covers it fully. In addition, if also no fourth galvanic nickel layer or a fourth galvanic layer is provided, the lubricant layer is positioned atop the second galvanic nickel layer and preferably covers it fully.

The lubricant layer may also be positioned in the solder section, preferably completely atop the electrical plug connector contact. In this case, the lubricant layer additionally optionally covers the tin layer, the fourth galvanic nickel layer or the fourth galvanic layer or the first galvanic layer. The lubricant layer covers the first galvanic layer when the fourth galvanic nickel layer or the fourth nickel layer, which are merely optional, are not provided. Accordingly, the tin layer may be positioned atop the first galvanic nickel layer when the fourth galvanic nickel layer or the fourth galvanic layer is not provided.

A terminal element comprises a housing, a printed circuit board positioned atop the housing and at least one electrical plug connector contact positioned within the housing and connected to the printed circuit board according to one of the embodiments. The terminal element is provided for connection to a complementary further terminal element having at least one further plug connector contact complementary to the electrical plug connector contact.

### BRIEF DESCRIPTION OF THE DRAWINGS

The electrical plug connector contact is elucidated in detail hereinafter in association with schematic drawings. The figures show:

FIG. 1a: an electrical plug connector contact in a first embodiment with a layer sequence;

FIG. 1b: a section view along a section plane A-A shown in FIG. 1a through the layer sequence;

FIG. 1c: a section view along a section plane B-B shown in FIG. 1a through the layer sequence;

FIG. 2a: an electrical plug connector contact in a second embodiment with a layer sequence;

FIG. 2b: a section view along a section plane A-A shown in FIG. 2a through the layer sequence;

FIG. 2c: a section view along a section plane B-B shown in FIG. 2a through the layer sequence;

FIG. 3a: a terminal element prior to mating with electrical plug connector contacts in a perspective view;

FIG. 3b: a terminal element fully mated with electrical plug connector contacts in a perspective view;

FIG. 4: results of a stress test on an electrical plug connector contact;

FIG. 5a: results of further stress tests on an electrical plug connector contact according to the prior art;

FIG. 5b: results of further stress tests on the electrical plug connector contact according to FIG. 1a to 1c or 2a to 2c with the layer sequence according to FIG. 1a to 1c or 2a to 2c and FIG. 5 b;

FIG. 6a: a scanning electron micrograph of a layer sequence of an electrical plug connector contact without fine-grain additive in a cross-sectional view;

FIG. 6b: a scanning electron micrograph of a layer sequence of an electrical plug connector contact with a fine-grain additive in a cross-sectional view;

FIG. 6c: an enlargement of a layer of the layer sequence of FIG. 6a without fine-grain additive in a cross-sectional view;

FIG. 6d: an enlargement of a layer of the layer sequence of FIG. 6b with fine-grain additive in a cross-sectional view;

FIG. 7a: a current density diagram of a unipolar galvanic deposition of a phosphorus-containing nickel layer; and

FIG. 7b: a current density diagram of a bipolar galvanic deposition of a phosphorus-containing nickel layer.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

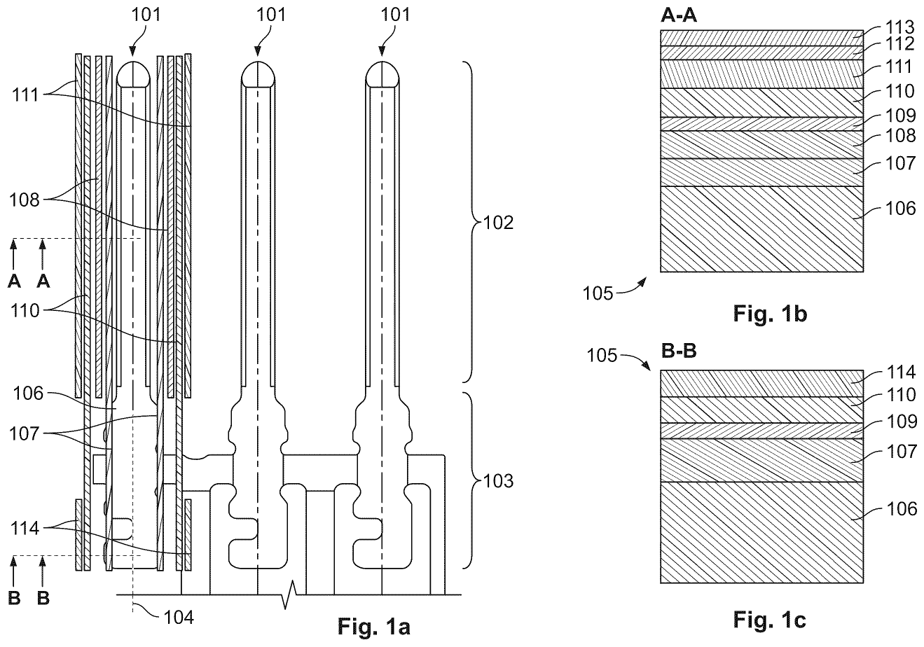

FIG. 1a shows a schematic of three electrical plug connector contacts 101 in a first embodiment. The electrical plug connector contacts 101 are shown in a state in which they are part of a blank punched strip section by way of example.

The electrical plug connector contact 101 has a terminal section 102 and a solder section 103, which can also be referred to as a solder leg 103. The terminal section 102 and the solder section 103 are fixedly connected to one another. In other words, the electrical plug connector contact 101 is monolithic, i.e. the terminal section 102 and the solder section 103 are formed by different sections of one body. The terminal section 102 and the solder section 103 are arranged such that they are opposite one another in a main direction of extension 104 of the electrical plug connector contact 101, which can also be referred to as assembly direction 104.

The electrical plug connector contact 101 according to FIG. 1 is designed as a plug by way of example. In this case, the terminal section 102 takes the form of a contact pin and is designed for engagement in a complementary coupling or a socket contact. Of course, the terminal section 102 may also be in socket form and designed to receive a complementarily or correspondingly designed plug contact.

The electrical plug connector contact 101 has a base material 106 and a layer sequence 105 positioned atop the base material 106, which is positioned atop a surface of the base material 106. The arrangement of the layer sequence 105 and the extension of individual layers of the layer sequence 105 in the main direction of extension 104 is indicated schematically for one of the electrical plug connector contacts 101 in FIG. 1a.

FIG. 1b shows a section view along a section plane A-A shown in FIG. 1a through the layer sequence 105. FIG. 1c shows a section view along a section plane B-B shown in FIG. 1a through the layer sequence 105. The first cross section A-A runs in the region of the terminal section 102, while the second cross section B-B runs in the region of the solder section 103 on an opposite side from the terminal section 102.

The individual layers of the layer sequence 105 preferably fully or at least partly enclose the electrical plug connector contact 101 azimuthally around the main direction of extension 104.

The layer sequence 105 has, in the terminal section 102, a first galvanic nickel layer 107, a second galvanic nickel layer 108, a third galvanic nickel layer 109, a fourth galvanic nickel layer 110, a gold layer 111, a sealing layer 112, and a lubricant layer 113. The galvanic nickel layers 7, 8, 9, 10 are also referred to as nickel layers 7, 8, 9, 10 in the description that follows. The third nickel layer 109, the sealing layer 112 and the lubricant layer 113 are not shown in FIG. 1a for the sake of simplicity. The third nickel layer 109, the fourth nickel layer 110 and/or the gold layer 111 and/or the sealing layer 112 and/or the lubricant layer 113 may also be omitted.

The base material 106 comprises a copper alloy by way of example. However, the base material 106 may also comprise a zinc, tin, silicon, nickel, iron and/or steel alloy. The first nickel layer 107 is positioned atop the base material 106. The first nickel layer 107 is positioned atop the base material 106 both in the terminal section 102 and in the solder section 103. The first nickel layer 107 preferably fully covers the base material 106.

Positioned atop the first nickel layer 107 in the terminal section 102 is a second nickel layer 108. The second nickel layer 108 preferably fully covers the first nickel layer 107 in the terminal section 102. The second nickel layer 108 may likewise be deposited galvanically, for example. The second nickel layer 108 is omitted in the solder section 103.

The first and second nickel layers 107, 108 are each polycrystalline, i.e. each have a plurality of crystallites which are separated from one another by grain boundaries. In the embodiment according to FIG. 1, the first nickel layer 107 takes the form of a matt nickel layer by way of example. The second nickel layer 108 takes the form of a moderately shiny or highly shiny nickel layer by way of example. The second nickel layer 108 may have a fine-grain structure by comparison with the first nickel layer 107. Conversely, the first nickel layer 107 may have a coarse-grain structure by comparison with the second nickel layer 8.

This has the effect that the second nickel layer 108 is harder than the first nickel layer 107. For that reason, the electrical plug connector contact 101 has improved wear characteristics in the region of the terminal section 102. As a result, the anticorrosion properties of the nickel and of the layer sequence 105 can be maintained over a long period. In addition, the anticorrosion properties can be maintained even under high loads acting on the electrical plug connector contact 101.

For example, it is possible that the second nickel layer 108 has crystallites with an average grain size smaller than an average grain size of the crystallites of the first nickel layer 107.

The effect that the grain size of the crystallites of the second nickel layer 108 is smaller than the grain size of the crystallites of the first nickel layer 107 can be achieved, for example, in that a fine-grain additive is used in the deposition of the second nickel layer 108. In that case, the second nickel layer 108 includes the fine-grain additive since the fine-grain additive is incorporated into the second nickel layer 108 in the course of the deposition of the second nickel layer 108. These residues of the fine-grain additive modify the crystal growth within the second nickel layer 108 in such a way that it can have a fine-grain structure by comparison with the first nickel layer 107.

The third nickel layer 109 is positioned atop the second nickel layer 108 in the region of the terminal section 102 and atop the first nickel layer 107 in the region of the solder section 3.

The third nickel layer 109 preferably fully covers the second nickel layer 108 in the region of the terminal section 102. Moreover, the third nickel layer 109 preferably fully covers the first nickel layer 107 in the region of the solder section 103. The third nickel layer 109 may also be referred to as a nickel strike layer. The third nickel layer 109 is intended to provide improved adhesion of a fourth nickel layer 110. The third nickel layer 109 can also be omitted.

The fourth nickel layer 110 is positioned above the second nickel layer 108 and atop the third nickel layer 109 in the region of the terminal section 102 and above the first nickel layer 107 and atop the third nickel layer 109 in the region of the solder section 103. If no third nickel layer 109 is provided for promotion of adhesion, the fourth nickel layer 110 is positioned directly atop the second nickel layer 108 in the region of the terminal section 102 and directly atop the first nickel layer 107 in the region of the solder section 103. The fourth nickel layer 1010 preferably fully covers the second nickel layer 108 or the optional third nickel layer 109 in the region of the terminal section 102. In addition, the fourth nickel layer 109 preferably fully covers the first nickel layer 107 or the optional third nickel layer 109 in the region of the solder section 3.

In addition to nickel, the fourth nickel layer 110 also includes phosphorus. For example, a phosphorus content of the fourth nickel layer 110 may be eleven to sixteen percent by weight. As an alternative to the phosphorus-containing fourth nickel layer 110, the layer sequence may include a fourth layer 110, which, although it likewise includes nickel, should not be described as a nickel layer since this comprises a PdNi alloy having a proportion by mass of, for example, 80%-wt Pd and 20%-wt Ni.

The fourth nickel layer 110 is more brittle and less noble than the second nickel layer 108. The fact that the second nickel layer 108 is positioned merely in the terminal section 102 and not in the solder section 103 as well has the advantage that delamination of the fourth nickel layer 110 in the solder section 103 at high temperatures and loads is avoided. The fourth layer 110 having the PdNi alloy has improved adhesion to the first nickel layer 107 and the optional third nickel layer 910 in the region of the solder section 103 by comparison with the phosphorus-containing fourth nickel layer 110.

In the region of the terminal section 102, the gold layer 111 is positioned atop the fourth nickel layer 110 or the fourth layer 110. The terminal section 102 of the electrical plug connector contact 101 is designed as a plug in the embodiment of FIG. 1. The gold layer 111 is preferably positioned completely in the region of the second nickel layer 109 or completely in the region of the terminal section 102 and covers it radially on the outside, based on the main direction of extension 104. The gold layer 111 additionally protects the electrical plug connector contact 101 and the nickel layers 107, 108, 109, 1010 from environmental influences. In addition, the third nickel layer 109 in the terminal section 102 is positioned between two less noble layers, namely the second nickel layer 108 and the gold layer 111, which has a positive effect on the corrosion balance of the electrical plug connector contact 101.

Atop the gold layer 111 is positioned a lubricant layer 113, which may, for example, comprise PFPE. A sealing layer 112 may be positioned between the gold layer 111 and the lubricant layer 113. Although the gold layer 111, the sealing layer 112 and the fabric layer 113 are optional, they improve corrosion protection and additionally reduce abrasion in the use of the electrical plug connector contact 1.

For connection of the electrical plug connector contact 101 to a (printed) circuit board, a tin layer 114 is positioned in the region of the solder section 103 and opposite the terminal section 102. However, the tin layer 114 can also be omitted.

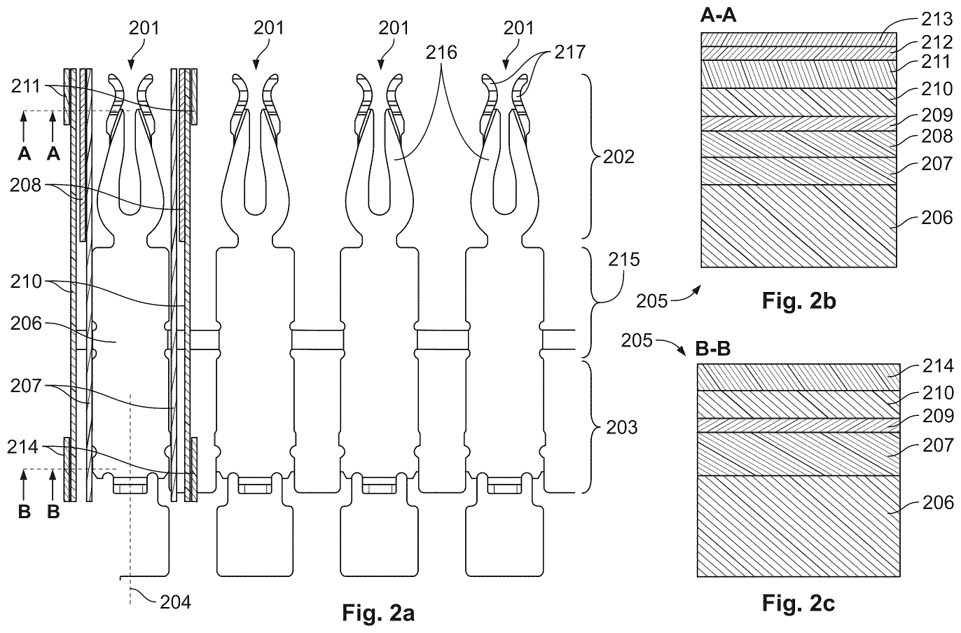

FIG. 2a shows a schematic of four electrical plug connector contacts 201 in a second embodiment. FIG. 2b shows a section view along a section plane A-A shown in FIG. 2a through the layer sequence 5. FIG. 2c shows a section view along a section plane B-B shown in FIG. 2a through the layer sequence 5. The first cross section A-A runs in the region of the terminal section 202, while the second cross section B-B runs in the region of the solder section 203 on an opposite side from the terminal section 202.

The electrical plug connector contact 201 according to the second embodiment is essentially identical to the electrical plug connector contact 101 elucidated in FIGS. 1a to 1c. The description that follows will elucidate only differences in the electrical plug connector contact 201 according to the second embodiment from the electrical plug connector contact 101 according to the first embodiment. Similar reference symbols will be used for similar or identical elements.

The electrical plug connector contact 201 according to FIG. 2, in addition to the terminal section 202 and the solder section 203, additionally has a connecting section 215. The connecting section 215 is arranged between the terminal section 202 and the solder section 203 based on assembly direction 205, and connects the terminal section 202 and the solder section 203 to one another.

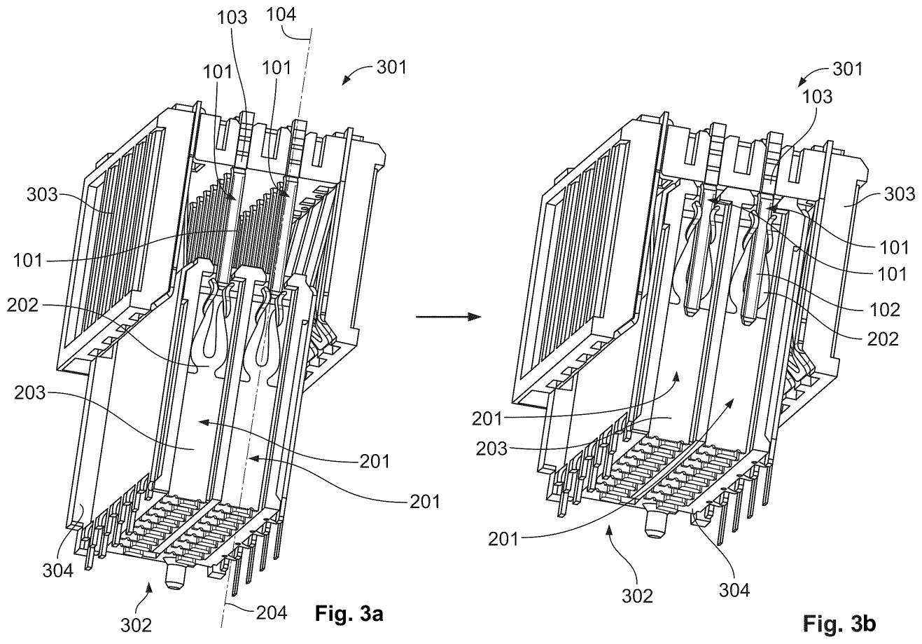

In contrast to the terminal section 102 of the electrical plug connector contact 1 according to FIG. 1, the terminal section 202 of the electrical plug connector contact 201 is designed as a spring coupling 216, i.e. the electrical plug connector contact 201 according to FIG. 2 is designed to accommodate the electrical plug connector contact 101 according to FIG. 1. The spring coupling 216 has a tulip 217. For that reason, the gold layer 211 in the embodiment according to FIG. 2 is positioned solely in the region of the tulip 215. However, it is not obligatory that the gold layer 211 is positioned solely in the region of the tulip 217. For example, the gold layer 211 may be positioned over the entire terminal section 202, i.e. in the illustrative embodiment of FIG. 2a over the entire spring coupling 216. The accommodating of the electrical plug connector contact 101 according to FIG. 1 in the spring coupling 216 is illustrated in FIG. 3.

FIG. 3 shows a schematic of a first terminal element 301 in a perspective view. The first terminal element 301 may also be referred to as blade-side terminal element 301. The first terminal element 301 has a first housing 303, which can also be referred to as blade housing 303. For example, the first terminal element 301 has a plurality of electrical plug connector contacts 101 according to FIGS. 1a to 1c, which are positioned in the first housing 303. It may also be sufficient when the first terminal element 301 only has one electrical plug connector contact 101 according to FIG. 1. The first terminal element 301 may, for example, be part of a backplane bus and thus be used, for example, in a control cabinet.

FIG. 3 also shows a complementary second terminal element 302 having a plurality of electrical plug connector contacts 201 according to FIGS. 2a to 2c, positioned in a second housing 304, which can also be referred to as spring housing 304, of the second terminal element 302. It may also be sufficient when the second terminal element 302 only has an electrical plug connector contact 202 according to FIG. 2.

FIG. 3 illustrates the engagement of the second terminal element 302 in the first terminal element 301, where the electrical plug connector contacts 101 according to FIGS. 1a to 1c of the first terminal element 301 engage in the electrical plug connector contacts 201 according to FIGS. 2a to 2c of the second terminal element 302. In principle, it is also possible that the first terminal element 301 engages in the second terminal element 302, where the electrical plug connector contacts 101 according to FIGS. 1a to 1c of the first terminal element 301 engage in the electrical plug connector contacts 201 according to FIGS. 2a to 2c of the second terminal element 302.

The electrical plug connector contacts 101 of the first terminal element 301 may be connected to a first printed circuit board (not shown in FIG. 3) which is positioned on the first housing. Alternatively or additionally, the electrical plug connector contacts 201 of the second terminal element 302 may be connected to a second printed circuit board (not shown in FIG. 3) which is positioned on the second housing. The printed circuit boards may be positioned, based on assembly direction 104, 204, for example, on opposite housing walls of the first and second housing 303, 304, although this is not absolutely necessary since the printed circuit boards may be positioned arbitrarily on the respective housings 303, 304. Alternatively, at least one of the printed circuit boards or both printed circuit boards may be omitted. In this case, the electrical plug connector contacts 101, 201 are each designed for connection to one printed circuit board.

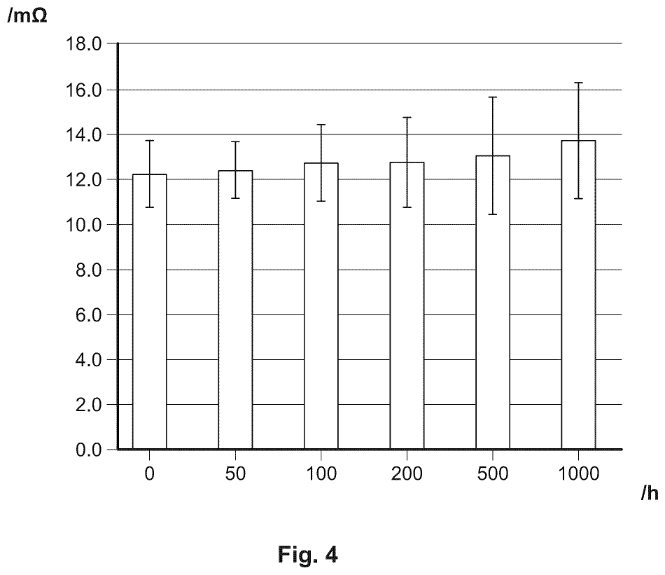

FIG. 4 shows a schematic of results of a stress test on an electrical plug connector contact 101, 201 according to FIG. 1 or FIG. 2. An abscissa shows a test duration in hours. An ordinate shows an ohmic resistance of the electrical plug connector contact 101, 201 in mΩ. The electrical plug connector contact 101, 201 was exposed to a temperature of 125° C. (dry heat test). FIG. 4 shows that the change in resistance has increased by less than 5 mΩ after 1000 hours. This shows the improved wear characteristics of the electrical plug connector contact 101, 201. In addition, no corrosion occurs in spite of the load.

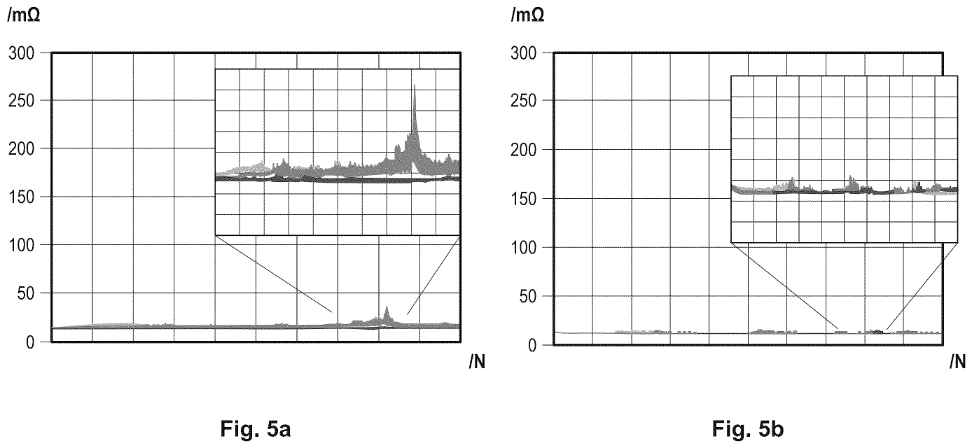

FIGS. 5a and 5b each show further stress tests. FIG. 5a shows a stress test on an electrical plug connector contact according to the prior art, while FIG. 5b shows a stress test on the electrical plug connector 101, 201 of FIG. 1 or 2. In this case, an ohmic resistance in mΩ is shown as a function of a number of plug-in cycles N.

A plug-in cycle is defined in that the electrical plug connector contact 101, 201 is connected to the complementary plug connector contact 201, 101 and is moved a definable distance in assembly direction 104, 204 within a definable period of time. For example, the electrical plug connector contact 101, 201 within one cycle can be moved by ±25 μm within one second in assembly direction 104, 204. FIGS. 5a and 5b show results after a total of 100 000 cycles by way of example. Additionally shown are magnifications of the relevant parts of the diagrams, in order to better illustrate changes in resistance.

While a significant change in resistance in the case of the electrical plug connector contact can be detected according to the prior the art as the number of cycles increases, resistance in the case of the electrical plug connector contact 101, 202 essentially does not increase with the number of plug-in cycles. This indicates that the improved wear properties mean that there is little or no diffusion into the base material 106, 206 of the electrical plug connector contact 101, 201, and that there is no formation of intermetallic phases that adversely affect the quality of the electrical plug connector contact 101, 201. As a result, the electrical plug connector contact 101, 201 has a longer lifetime.

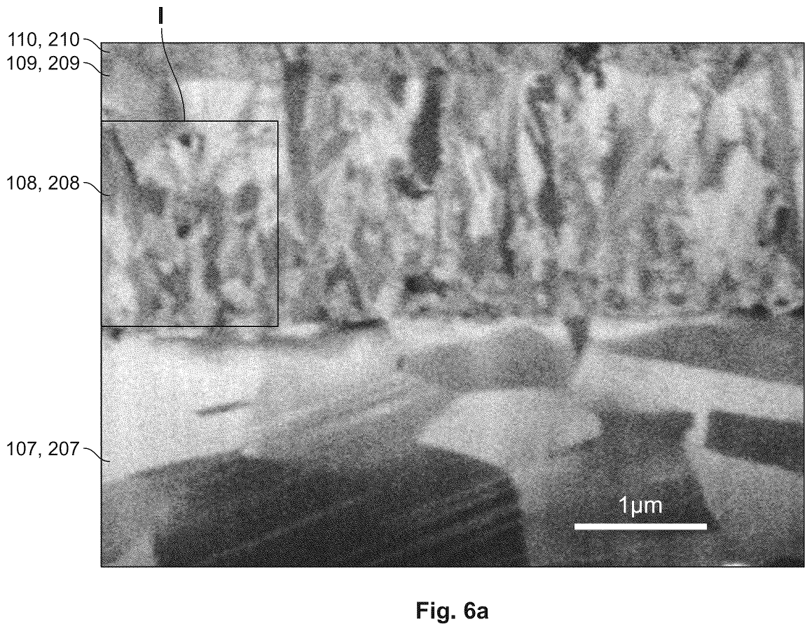

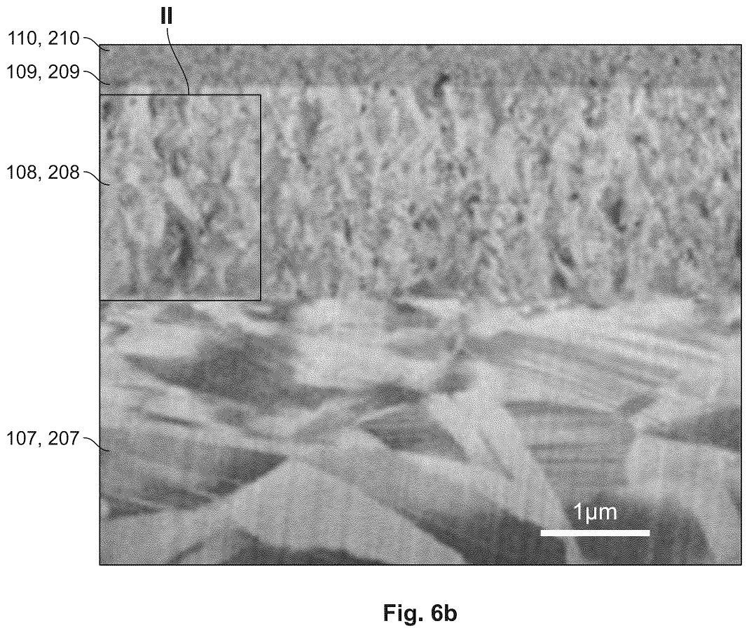

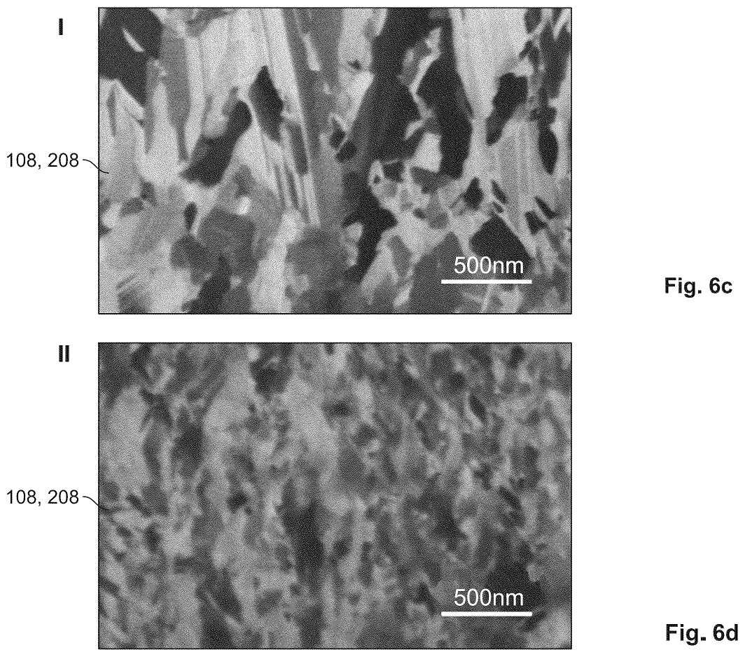

FIG. 6a shows a schematic of a scanning electron micrograph of a layer sequence 105, 205, the second galvanic nickel layer 108, 208 of which includes no fine-grain additive, in cross section. The first galvanic nickel layer 107, 207 and the fourth layer 110, 210 shown in FIG. 6a likewise include no fine-grain additive, by way of example. Instead of the fourth layer 110, 210, the fourth galvanic nickel layer 110, 210 can also be provided. The third galvanic nickel layer 109, 209 is not apparent in FIG. 6a, since it is too thin. The third galvanic nickel layer 109, 209 also has no fine-grain additive by way of example.

In contrast to the first galvanic nickel layer 107, 207, the second galvanic nickel layer 108, 208 has smaller crystallites or grains by way of example. The first galvanic nickel layer 107, 207 which is free of fine-grain additive has, by way of example, essentially crystallites that are greater than 1 μm in size at least in one direction of extension, while the crystallites of the second galvanic nickel layer 108, 208 have, for example, predominantly grain sizes in the submicrometer range. However, the grain sizes shown and indicated should not be regarded as limiting, but are merely illustrative.

FIG. 6b shows a schematic of a scanning electron micrograph of a layer sequence 105, 205, the second galvanic nickel layer 108, 208 of which includes a fine-grain additive, in cross section. The first galvanic nickel layer 107, 207 and the fourth layer 110, 210 shown in FIG. 6a include no fine-grain additive, by way of example. Instead of the fourth layer 110, 210, the fourth galvanic nickel layer 110, 210 can also be provided. The third galvanic nickel layer 109, 209 is likewise not apparent in FIG. 6b, since it is too thin. The third galvanic nickel layer 109, 209 also has no fine-grain additive by way of example. The fine-grain additive of the second galvanic nickel layer 108, 208 is likewise not apparent, since it is positioned predominantly in the region of the grain boundaries in the second galvanic nickel layer 108, 208.

In principle, the first galvanic nickel layer 107, 207, the second galvanic nickel layer 108, 208, the optional third galvanic nickel layer 109, 209 and the optional fourth layer 110, 210 or the fourth galvanic nickel layer 110, 210 may each individually include or not include a fine-grain additive. Preferably, however, at least the second galvanic nickel layer 108, 208 includes the fine-grain additive.

As in FIG. 6a, the second galvanic nickel layer 108, 208 has smaller crystallites than the first galvanic nickel layer 107, 207. However, it is apparent in FIG. 6b that the microstructures of the second galvanic nickel layers 108, 208 of FIGS. 6a and 6b differ since the second galvanic nickel layer 108, 208 of FIG. 6a, in contrast to the second galvanic nickel layer 108, 208 of FIG. 6a, includes a fine-grain additive.

FIG. 6c shows schematic enlargements of the second galvanic nickel layers 108, 208 of FIGS. 6a and 6b. The second galvanic nickel layer 108, 208 with fine-grain additive according to FIG. 6b has smaller crystallites than the second galvanic nickel layer 108, 208 without fine-grain additive according to FIG. 6a. The fact that the grain size of the crystallites of the second galvanic nickel layer 108, 208 with fine-grain additive is smaller than the crystallites of the second galvanic nickel layer 108, 208 without fine-grain additive means that at least some of the crystallites of the second galvanic nickel layer 108, 208 with fine-grain additive have smaller grain sizes on average at least in one direction of extension than the crystallites of the second galvanic nickel layer 108, 208 without fine-grain additive.

In the illustrative embodiment of FIG. 6c, for example, 25% to 75% of the crystallites of the second galvanic nickel layer 108, 208 with fine-grain additive according to FIG. 6b may have average grain sizes, for example, above 500 nm in at least one direction of extension. For example, it is likewise possible, for example, for 25% to 75% of the crystallites of the second galvanic nickel layer 108, 208 without fine-grain additive according to FIG. 6 a to have average grain sizes, for example, below 500 nm in at least one direction of extension. These grain sizes should be regarded merely as illustrative figures and not as being limiting in respect of the electrical plug connectors 101, 201. What is instead being shown is a possible embodiment that has the described advantages of the improved wear properties of the electrical plug connector 101, 202.

In addition, the grain boundary density of the second galvanic nickel layer 108, 208 with fine-grain additive according to FIG. 6b is higher than the grain boundary density of the second galvanic nickel layer 108, 208 without fine-grain additive according to FIG. 6a. In other words, the microstructure with fine-grain additive is finer. Moreover, the crystallites of the second galvanic nickel layer 108, 208 with fine-grain additive are more rounded than the crystallites of the second galvanic nickel layer 108, 208 without fine-grain additive.

FIGS. 6a and 6b, in addition to the first galvanic and second galvanic nickel layer 107, 207, 108, 208, each show the fourth galvanic nickel layer 110, 210. Alternatively, rather than the fourth galvanic nickel layer 110, 210, the fourth layer 110, 210 may be provided. The fourth galvanic nickel layer 110, 210 may be galvanically deposited like the first galvanic nickel layer 107, 207, the second galvanic nickel layer 108, 208, the third galvanic nickel layer 109, 209 and the fourth layer 110, 210, for example by a DC deposition. However, the fourth galvanic nickel layer 110, 210 may also be deposited by a pulsed current deposition on the second or third galvanic nickel layer 108, 208, 109 ,209.

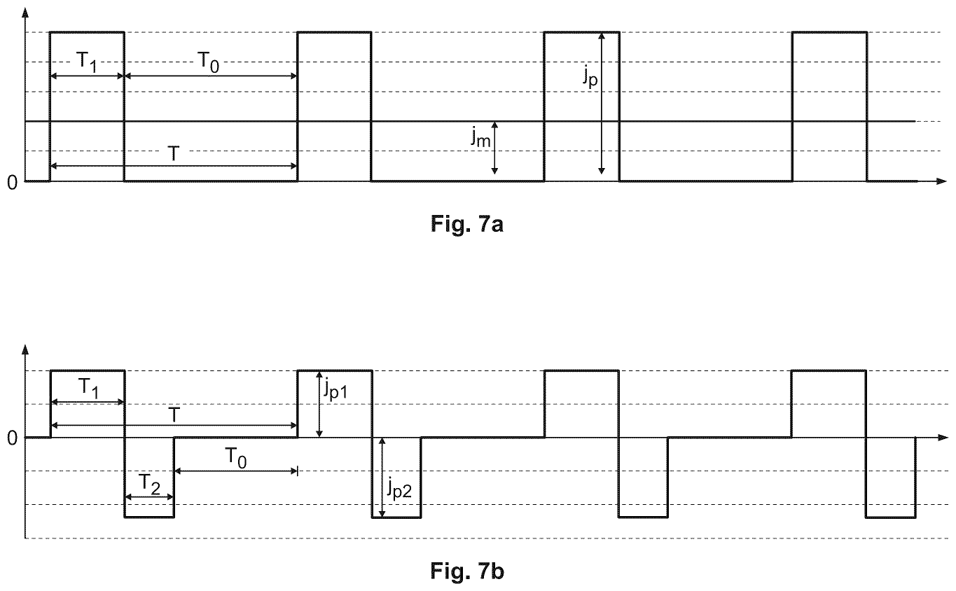

FIG. 7a shows a schematic of an illustrative current density diagram for the galvanic pulsed current deposition of the fourth galvanic nickel layer 110, 210. A current density is plotted here against a coating time. FIG. 7a shows a unipolar galvanic deposition of the fourth galvanic nickel layer 110, 210.

The current density j has a square wave profile with a period T and maxima jP, where the current density only assumes values greater than or equal to zero, since the deposition is unipolar. Within a period T, the maximum current density jP is maintained for a period of time T1, while the current density assumes the value of zero for a period of time T0, such that T=T1+T0. FIG. 7a also shows a median value jM of the current density.

FIG. 7b shows a schematic of a further illustrative current density diagram for the galvanic pulsed current deposition of the fourth galvanic nickel layer 110, 210. Again, a current density is plotted here against a coating time. FIG. 7b shows a bipolar galvanic deposition of the fourth galvanic nickel layer 110, 210.

In contrast to unipolar deposition, current density additionally also assumes negative values within a period T, i.e. deposition is accomplished not by DC but by AC. The current density profile of FIG. 7 b also has a square wave profile. Within a period T, a maximum current density jP1 is maintained for a period of time T1. The current density then assumes a minimum of jP2 for a period of time T2 and the value of zero for a period of time T0, such that T=T1+T2+T0.

Compared to DC deposition, a fourth galvanic nickel layer 110, 210 deposited with pulsed current parameters shows a more uniform and finer-grain layer structure. Pulsed current deposition brings about a reduction in grain size and an increase in the shine level of this layer, and a higher layer hardness.

The fourth galvanic nickel layer 110, 210 deposited with pulsed current parameters also has a higher phosphorus content compared to a fourth galvanic nickel layer 110, 210 positioned by DC deposition. A local phosphorus distribution of the fourth galvanic nickel layer 110, 210 deposited with pulsed current is comparable to a phosphorus distribution of nickel layers deposited electrolessly.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An electrical plug connector contact comprising:
a terminal section for contacting with a complementary further electrical plug connector contact,
wherein a first galvanic nickel layer is positioned atop the terminal section,
wherein a second galvanic nickel layer is positioned atop the first galvanic nickel layer.

2. The electrical plug connector contact as claimed in claim 1,
wherein the first galvanic nickel layer takes the form of a matt nickel layer,
wherein the second galvanic nickel layer takes the form of a moderately shiny or highly shiny nickel layer.

3. The electrical plug connector contact as claimed in claim 1,
having a solder section fixedly bonded to the terminal section,
wherein the terminal section and the solder section are arranged opposite one another in relation to an assembly direction of the electrical plug connector contact,
wherein a solder bond can be positioned in the solder section,
wherein the first galvanic nickel layer is positioned atop the terminal section and atop the solder section,
wherein the second galvanic nickel layer is positioned solely in the region of the terminal section atop the first galvanic nickel layer.

4. The electrical plug connector contact as claimed in claim 1,
wherein a third galvanic nickel layer is positioned atop the second galvanic nickel layer,
wherein the third galvanic nickel layer takes the form of an adhesion promoter layer.

5. The electrical plug connector contact as claimed in claim 1,
wherein a fourth galvanic nickel layer is positioned above the second galvanic nickel layer,
wherein the fourth galvanic nickel layer includes phosphorus, in particular 11-16%-wt phosphorus.

6. The electrical plug connector contact as claimed in claim 5,
wherein the fourth galvanic nickel layer includes a dispersion additive,
wherein the dispersion additive comprises one of the following materials or a combination of materials:
silicon carbide, silicon dioxide, boron nitride, an aluminum ceramic.

7. The electrical plug connector contact as claimed in claim 1,
wherein a fourth galvanic layer is positioned above the second galvanic nickel layer,
wherein the fourth galvanic layer includes a palladium-nickel alloy, in particular a palladium-nickel alloy having a proportion by mass of 80%-wt palladium and 20%-wt nickel.

8. The electrical plug connector contact as claimed in claim 3,
wherein the fourth galvanic nickel layer or the fourth galvanic layer is positioned in the region of the terminal section atop the third galvanic nickel layer or atop the second galvanic nickel layer, and/or
wherein the fourth galvanic nickel layer or the fourth galvanic layer is positioned in the region of the solder section atop the third galvanic nickel layer or atop the first galvanic nickel layer.

9. The electrical plug connector contact as claimed in claim 4,
wherein the first galvanic nickel layer fully covers the terminal section and the solder section and the second galvanic nickel layer fully covers the first galvanic nickel layer in the region of the terminal section, and/or
wherein the third galvanic nickel layer fully covers the first galvanic nickel layer in the region of the solder section and the second galvanic nickel layer in the region of the terminal section, and/or
wherein the fourth galvanic nickel layer fully covers the third galvanic nickel layer in the terminal section and in the solder section.

10. The electrical plug connector contact as claimed in claim 5,
wherein a gold layer is positioned atop the fourth galvanic nickel layer or atop the fourth galvanic layer.

11. The electrical plug connector contact as claimed in claim 10,
wherein a sealing layer is positioned atop the gold layer.

12. The electrical plug connector contact as claimed in claim 10,
wherein a lubricant layer is disposed atop the gold layer or atop the sealing layer.

13. The electrical plug connector contact as claimed in claim 4,
wherein, in the region of the solder section, in a region opposite the terminal section based on assembly direction, a tin layer is positioned atop the fourth galvanic nickel layer or the fourth galvanic layer.

14. The electrical plug connector contact as claimed in claim 1,
wherein the second galvanic nickel layer includes a fine-grain additive.

15. A terminal element
having a housing, a printed circuit board positioned on the housing and at least one electrical plug connector contact as claimed in claim 1 which is positioned within the housing and connected to the printed circuit board,
wherein the terminal element is provided for connection to a complementary further terminal element having at least one further plug connector contact complementary to the electrical plug connector contact.
